(19) United States
(12) Patent Application Publication
(10) Pub. No.: US 2015/0371419 A1
(43) Pub. Date: Dec. 24, 2015

(54) INSPECTION DATA DISPLAY CONTROL APPARATUS, METHOD, AND RECORDING MEDIUM

(71) Applicant: FUJIFILM Corporation, TOKYO (JP)

(72) Inventor: TAKASHI HOSHINO, Kanagawa-ken (JP)

(21) Appl. No.: 14/836,921

(22) Filed: Aug. 26, 2015

Related U.S. Application Data
(63) Continuation of application No. PCT/JP2014/001601, filed on Mar. 20, 2014.

(30) Foreign Application Priority Data
Mar. 29, 2013 (JP) 2013-071273

(51) Int. Cl. G06T 11/20; G06T 11/00; G06T 11/60

(52) U.S. Cl. CPC G06T 11/206; G06T 11/60; G06T 11/001

(57) ABSTRACT

Providing an inspection data obtaining unit that obtains inspection data of a plurality of inspection items obtained in time series and a display control unit that graph-displays the inspection data of each inspection item obtained by the inspection data obtaining unit, in which the display control unit attaches a data label only to a change point in a graph of each inspection item and displays.

### CROSS-REFERENCE TO RELATED APPLICATIONS

This application is a Continuation of PCT International Application No. PCT/JP2014/001601 filed on Mar. 20, 2014, which claims priority under 35 U.S.C. §119 (a) to Japanese Patent Application No. 2013-071273 filed on Mar. 29, 2013. Each of the above applications is hereby expressly incorporated by reference, in its entirety, into the present application.

### BACKGROUND

The present disclosure relates to an inspection data display control apparatus, method, and program for displaying inspection data of a plurality of inspection items obtained in time series.

Recently, when a medical examination is performed on a patient by a doctor, it has been practiced to display a plurality of inspection results performed on the patient as reference information for determining the disease name and treatment policy.

A wide variety of inspections is performed on a patient and if a patient is suspected to have a specific disease, diagnosis or treatment is performed with reference to each inspection result of a plurality of inspection items considered as important for the diagnosis of the specific disease in actual medical sites.

Here, when displaying aforementioned inspection results of a plurality of inspection items as graphs on a display, it is proposed to attach and display numerical values to the inspection data of the graphs (refer to, for example, Japanese Unexamined Patent Publication No. 2010-128856).

### SUMMARY

But, there may be a case where inspection items amount to a large number and if the patient is suffering from a plurality of diseases, the number of inspection items is further increased. Therefore, if all inspection data of the graphs of the many inspection items are indicated with numerical values, it is very difficult to clearly observe the graphs because numerical values overlap with each other. If inspection data are graph-displayed by setting the display period long, in particular, many inspection data are plotted within the limited display area, thereby causing a problem that the numerical values are increasingly difficult to clearly observe and also the graphs are difficult to confirm.

In view of the circumstances described above, the present disclosure provides an inspection data display control apparatus, method, and program capable of attaching and displaying, when data labels, such as numerical values of inspection data, are attached to the graphs of inspection data of a plurality of inspection items and displayed, important data labels without causing a difficulty in observing the numerical values of the data labels and the graphs.

An inspection data display control apparatus of the present disclosure is an apparatus, including an inspection data obtaining unit that obtains inspection data of a plurality of inspection items obtained in time series and a display control unit that graph-displays inspection data of each inspection item obtained by the inspection data obtaining unit, in which the display control unit is a unit that attaches a data label only to a change point in a graph of each inspection item and displays.

In the inspection data display control apparatus of the present disclosure described above, the change point may be a point where the slope of the graph is changed from positive to negative or from negative to positive.

Further, the change point may be a point where the inspection data are changed from an abnormal value to a normal value or from a normal value to an abnormal value.

Still further, the change point may be a point where the inspection data are changed in an amount greater than a preset threshold value.

Further, the display control unit may be a unit that attaches the data label only to a point of the change points where the inspection data have an abnormal value.

Still further, the display control unit may be a unit that further attaches the data label to at least one point of a maximum value, a minimum value, and an end point of the graph of each inspection item, in addition to the change point.

Further, the display control unit may be a unit that attaches a numerical value of the inspection data as the data label.

Still further, the display control unit may be a unit that attaches a colored mark as the data label.

Further, the display control unit may be a unit capable of changing a display period of the inspection data.

An inspection data display control method of the present disclosure is a method for obtaining inspection data of a plurality of inspection items obtained in time series, and graph-displaying the obtained inspection data of each inspection item, in which, when graph-displaying the inspection data of each inspection item, a data label is attached only to a change point in a graph of each inspection item and displayed.

An inspection data display control program of the present disclosure is a program for causing a computer to function as an inspection data obtaining unit that obtains inspection data of a plurality of inspection items obtained in time series and a display control unit that graph-displays inspection data of each inspection item obtained by the inspection data obtaining unit, in which the display control unit attaches a data label only to a change point in a graph of each inspection item and displays.

According to the inspection data display control apparatus, method, and program of the present disclosure, when attaching data labels, such as numerical values of inspection data, to the graphs of inspection data of a plurality of inspection items and displaying, a data label is attached only to a change point in the graph of each inspection item and displayed. This allows an important data label to be attached without causing a difficulty in observing a numerical value of the data label and the graphs.

### BRIEF DESCRIPTION OF THE DRAWINGS

FIG. 1 is a block diagram of a medical care information display system that uses an embodiment of the inspection data display control apparatus of the present disclosure, illustrating a schematic configuration thereof.

FIG. 2 shows an example of a medical care information display screen.

FIG. 3 shows an example in which data labels are attached to all the inspection data of graphs of a plurality of inspection items.

FIG. 4 shows an example of a data label display method of a first embodiment of the present disclosure.

FIG. 5 shows an example of a data label display method of a second embodiment of the present disclosure.

FIG. 6 shows an example of a data label display method of a third embodiment of the present disclosure.

FIG. 7 shows an example in which data labels are attached only to the change points in the first and the second embodiments.

### DESCRIPTION OF EMBODIMENTS

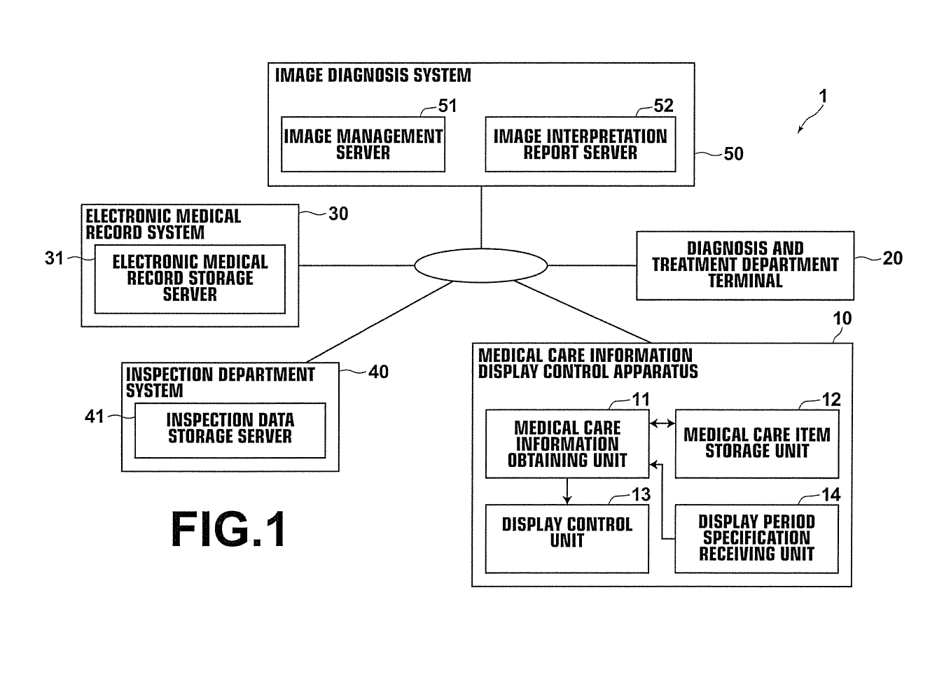

Hereinafter, a medical care information display system that uses a first embodiment of the inspection data display control apparatus, method, and program of the present disclosure will be described in detail with reference to the accompanying drawings. FIG. 1 is a block diagram of a medical care information display system 1 of the present embodiment, illustrating the schematic configuration thereof.

As illustrated in FIG. 1, the medical care information display system 1 of the present embodiment includes a medical care information display control apparatus 10, a diagnosis and treatment department terminal 20, an electronic medical record system 30, an inspection department system 40, and an image diagnosis system 50.

The medical care information display control apparatus 10, the diagnosis and treatment department terminal 20, and each system 30 to 50 in the medical care information system 1 are connected via a network, such as a wired or wireless LAN, or an Internet circuit.

The medical care information display control apparatus 10 will be described first. Note that the medical care information display control apparatus 10 includes an embodiment of the inspection data display control apparatus of the present disclosure.

The medical care information display control apparatus 10 receives identification information of a patient inputted at the diagnosis and treatment department terminal 20, collects medical care information of the patient from the electronic medical record server 30, the inspection department system 40, and the image diagnosis system 50, generates a medical care information display screen by integrating the collected information, and displays the screen on the diagnosis and treatment department terminal 20.

More specifically, the medical care information display control apparatus 10 includes a medical care information obtaining unit 11 (corresponding to the inspection data obtaining unit), a medical care information storage unit 12, a display control unit 13, and a display period specification receiving unit 14.

The medical care information display control apparatus 10 is a computer on which a medical care information display control program that includes an embodiment of the inspection data display control program of the present disclosure is installed. Execution of the medical care information display control program by the central processing unit (CPU) causes the medical care information obtaining unit 11, the display control unit 13, and the display period specification receiving unit 14 to function. The medical care information display control program described above may be a medical care information display control program recorded on a recording medium, such as a CD-ROM, or down-loaded from a server or the like via the Internet.

The medical care information obtaining unit 11 obtains, based on the identification information of a patient inputted at the diagnosis and treatment department terminal 20, medical care information associated with the identification information of the patient from each server of the system described above via the network. The medical care information includes basic information, such as the name, age, and gender of a patient, medication and drip infusion information, various types of inspection data, such as a sample test, a vital, and the like, and image diagnosis information.

The medical care information obtaining unit 11 temporarily stores the medical care data collected from each server based on the patient identification information in the medical care information storage unit 12. The medical care information storage unit 12 is composed of a storage device, such as a hard disk.

The display control unit 13 generates a medical care information display screen based on the medical care data, including inspection data outputted from the medical care information obtaining unit 11 and outputs the medical care information display screen to the diagnosis and treatment department terminal 20 for display.

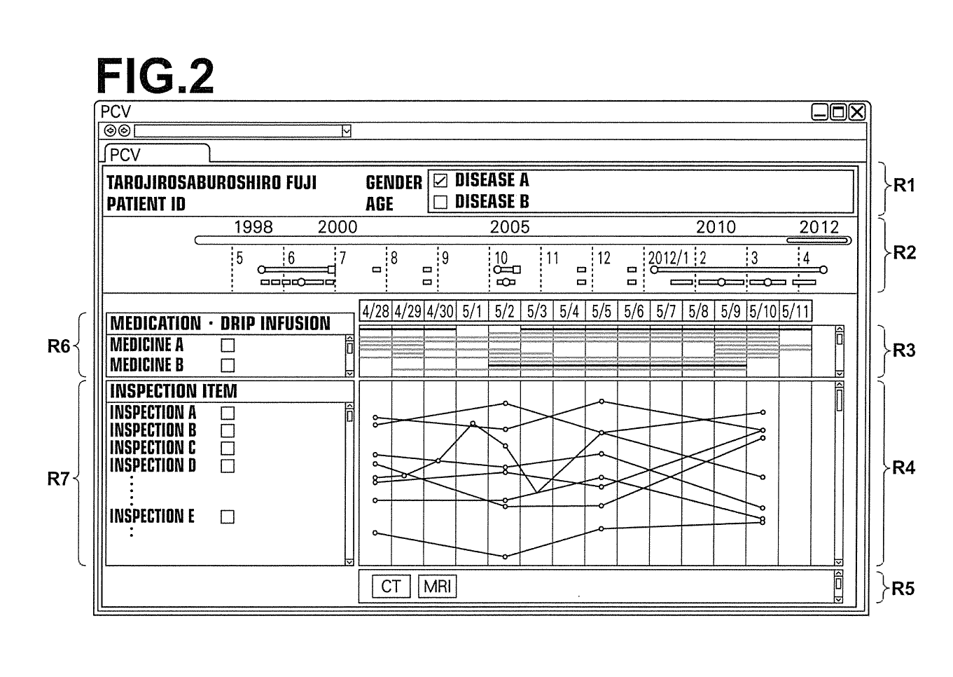

A medical care information display screen to be generated in the display control unit 13 will now be described. FIG. 2 shows an example of a medical care information display screen.

As shown in FIG. 2, the medical care information display screen includes a basic information display section R1, an inspection period display section R2, a medication period display section R3, an inspection data display section R4, an image examination information section R5, a medication list display section R6, and an inspection item list display section R7.

The basic information display section R1 is a section in which basic information of a patient is displayed, such as identification information of a patient (patient ID), name, age, gender, a history of disorders, and the like. For the history of disorders, a checkbox is displayed for each disease, as illustrated in FIG. 2. Then, a disease of interest is specified by checking the checkbox, and inspection data and image examination information of the disease are displayed.

The inspection period display section R2 is a section in which an inspection period of the patient is displayed and a period of inspection received by the patient is displayed by a horizontal bar graph. The medication period display section R3 is a section in which a medication period or a drip infusion period of the patient is displayed and a period of medication or drip infusion received by the patient is displayed by a horizontal bar graph.

The inspection data display section R4 is a section in which inspection data of a plurality of inspection items obtained in time series are displayed by line graphs. The horizontal axis of the inspection data display section R4 is a time axis while the vertical axis represents numerical values of the inspection data.

Although omitted in FIG. 2, the display control unit 13 attaches, for a graph of each inspection item displayed in the inspection data display section R4, a data label only to a change point of the graph and displays. The method of displaying the data label for the change point will be described in detail later.

The image examination information section R5 is a section in which image examination information of the patient is displayed. More specifically, a thumbnail image of an image captured by imaging the patient with a CT system or a MRI system is displayed. When the thumbnail image is selected, for example, by being clicked, the original image of the thumbnail image is displayed on a separate screen and an image interpretation report of the original image is also displayed.

The medication list display section R6 is a section in which types of medicines administered or drip-infused during each medication period displayed in the medication period display section R3 are list-displayed. In addition to the list-display of medicines, a checkbox is displayed for each medicine in the medication list display section R6. Then, the medication period of a medicine whose checkbox has been checked is highlighted in the medication period display section R3. More specifically, for example, the medication period of a medicine checked with the checkbox is color-displayed while the medication period of a medicine not checked with the checkbox is displayed in pale gray or similar color so as to be less noticeable.

The inspection item list display section R7 is a section in which inspection items of the inspection data displayed in the inspection data display section R4 are list-displayed. In addition to the list-display of inspection items, a checkbox is displayed for each inspection item in the inspection item list display section R7. Then, the inspection data of an inspection item whose checkbox has been checked are highlighted in the inspection data display section R4. More specifically, for example, the inspection data of an inspection item checked with the checkbox are color-displayed while the inspection data of an inspection item not checked with the checkbox are displayed in pale gray or similar color so as to be less noticeable.

Now, returning to FIG. 1, the display period specification receiving unit 14 receives a specification of a display period of inspection data to be displayed and outputs the display period information to the medical care information obtaining unit 11. The display period is a display period of inspection data a doctor or a similar person wants to observe with a particular attention and, for example, the date of a display start day and the date of a display end day are inputted and the period from the display start day to the display end day is the display period, and the inspection data during this display period are display target inspection data. Further, a display start month and a display end moth may be specified, instead of dates.

Then, based on the inputted display period information, the medical care information obtaining unit 11 described above obtains inspection data in the aforementioned display period from inspection data stored in an inspection storage server 41 and outputs the obtained inspection data to the display control unit 13.

Based on the inputted inspection data and the specified display period, the display control unit 13 graph-displays the inspection data by changing the display period of the horizontal axis of the inspection data display section R4 described above.

The diagnosis and treatment department terminal 20 is provided with a display, a keyboard, a mouse, and the like. The display of the diagnosis and treatment department terminal 20 displays the medical care information display screen shown in FIG. 2. The keyboard and the mouse of the diagnosis and treatment department terminal 20 receive an input of identification information of a patient, an input of the aforementioned display period of inspection data, a specifying input of the aforementioned checkbox, and the like.

The electronic medical record system 30 is a system that manages electronic medical records of a plurality of patients. The electronic medical record system 30 is provided with an electronic medical record storage server 31, and the electronic medical record storage server 31 includes electronic medical records of a plurality of patients associated with identification information of the patients. The electronic medical record system 30 obtains identification information of a patient inputted at the diagnosis and treatment department terminal 20 and outputs the electronic medical record information associated with the identification information to the medical care information display control apparatus 10. An electronic medical record includes information, such as basic information of a patient, a type of a medicine administered or drip-injected and a medication period, a history of disorders, and the like.

The inspection department system 40 is a system that manages inspection data of a plurality of patients. The inspection department system 40 is provided with an inspection data storage server 41, and the inspection data storage server 41 includes inspection data of a plurality of inspection items of each patient associated with the identification information of each patient. The inspection department system 40 obtains identification information of a patient inputted at the diagnosis and treatment department terminal 20 and outputs the inspection data associated with the identification information to the medical care information display control apparatus 10.

The image diagnosis system 50 is a system that manages image examination information of a plurality of patients. The image diagnosis system 50 is provided with an image management server 51 and an image interpretation report server 52. The image management server 51 includes a radiation image or a similar image of each patient associated with the identification information of each patient. The image interpretation report server 52 includes an image interpretation report generated by a doctor through observation of a radiation image or a similar image, and the image interpretation report is stored associated with the radiation image or the similar image stored in the image management server 51. The image diagnosis system 50 obtains identification information of a patient inputted at the diagnosis and treatment department terminal 20 and outputs a radiation image and an image interpretation report of the image associated with the identification information to the medical care information display control apparatus 10.

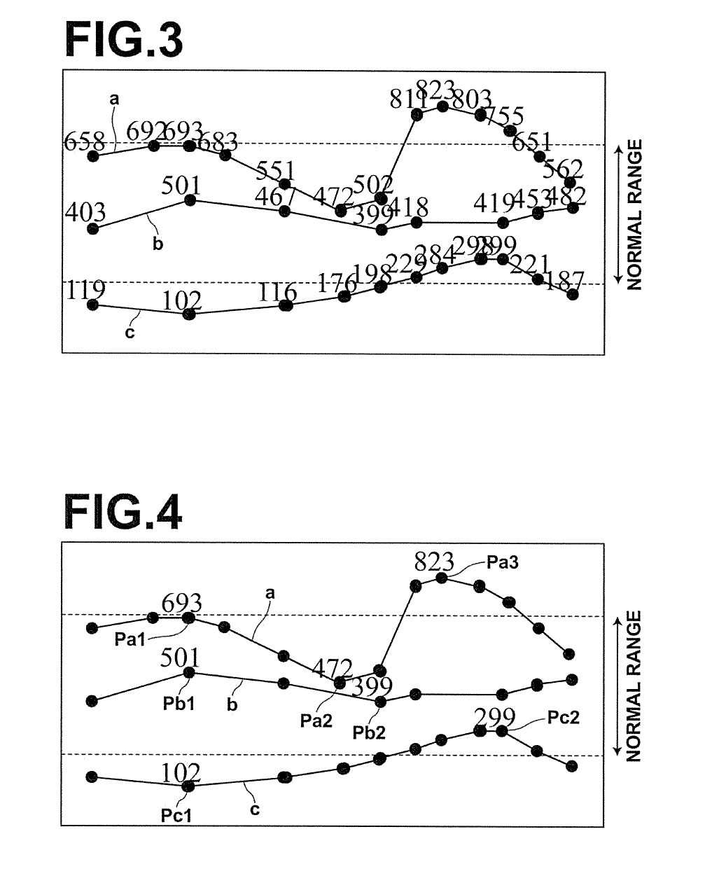

Next, an operation of the medical care information display system 1 of the present embodiment will be described with reference to FIGS. 3 to 7. Since the medical care information display system 1 has a distinguishing feature in the display method of a data label attached to a graph in the inspection data display section R4 described above, a description will be made, hereinafter, focusing mainly on that point.

As described above, the display control unit 13 of the present embodiment attaches a data label only to a change point of a graph of each inspection item and displays. But first, an example in which data labels are attached to all points of inspection items a to c is shown for comparison and to indicate values of each inspection data. Here, a numerical value of inspection data is indicated as the data label. The normal range shown in FIG. 3 indicates a range of normal values as the inspection data, and inspection data outside the normal range can be said to be abnormal values.

As illustrated in FIG. 3, the attaching data labels to all points of the graph of each inspection item results in that the data labels overlap with each other, thereby causing the display to be very difficult to observe.

Hence, the display control unit 13 of the present embodiment determines a point in each graph of each inspection item a to c where the slope of the graph is changed from positive to negative or from negative to positive as a change point and attaches a data label only to the change point. FIG. 4 shows an example in which a data label is attached in the foregoing manner.

As shown in FIG. 4, for the graph of the inspection item a, data labels are attached only to change points Pal and Pa3 where the slope of the graph is changed from positive to negative, and a change point Pat where the slope of the graph is changed from negative to positive. For the graph of the inspection item b, data labels are attached only to a change point Pb1 where the slope of the graph is changed from positive to negative and a change point Pb2 where the slope of the graph is changed from negative to positive. For the graph of the inspection item c, data labels are attached only to a change point Pc2 where the slope of the graph is changed from positive to negative and a change point Pc1 where the slope of the graph is changed from negative to positive.

As shown in FIG. 4, attaching a data label only to a change point of each graph makes the display very easy to observe and allows the trend of the graph to be confirmed by the data label of the change point, whereby information required for diagnosis may be obtained.

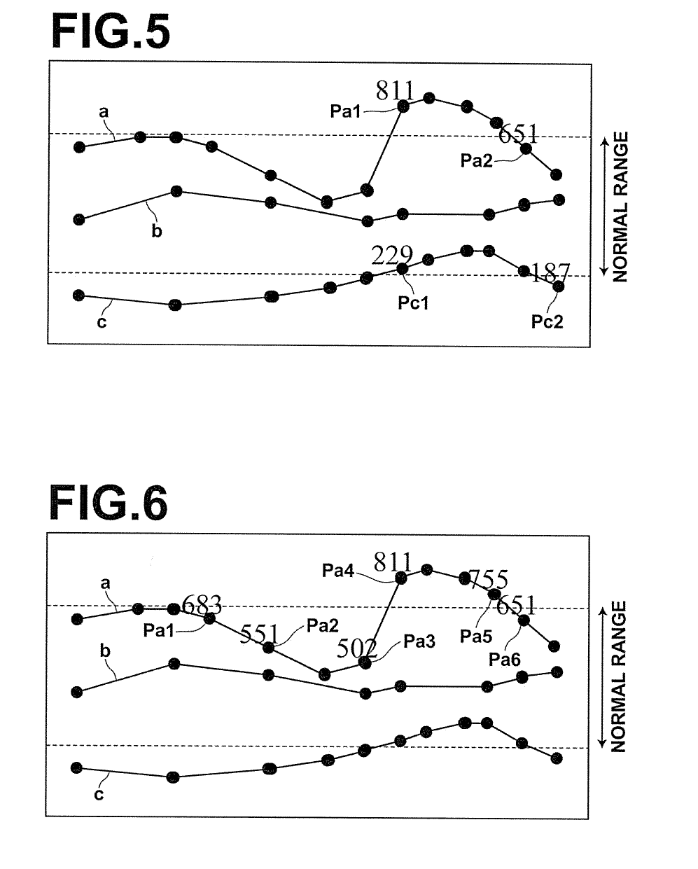

Next, a data label display method of a second embodiment will be described. In the second embodiment, the display control unit 13 determines a point in each graph of each inspection item a to c where the inspection data are changed from an abnormal value to a normal value or from a normal value to an abnormal value as a change point and attaches a data label only to the change point. FIG. 5 shows an example in which a data label is attached in the foregoing manner.

As shown in FIG. 5, for the graph of the inspection item a, data labels are attached only to a change point Pal where the inspection data are changed from a normal value to an abnormal value, and a change point Pa2 where the inspection data are changed from an abnormal value to a normal value. For the graph of the inspection item b, no data label is attached as there is no inspection data corresponding to a change point. For the graph of the inspection item c, data labels are attached only to a change point Pc2 where the inspection data are changed from a normal value to an abnormal value, and a change point Pc1 where the inspection data are changed from an abnormal value to a normal value.

As shown in FIG. 5, attaching a data label only to a change point of each graph makes the display very easy to observe and allows information required for diagnosis to be obtained, such as a timing of getting a disease with inspection data changed to an abnormal value and a timing of recovering from the disease with the inspection data changed to a normal value.

Next, a data label display method of a third embodiment will be described. In the third embodiment, the display control unit 13 determines a point in each graph of each inspection item a to c where the inspection data are changed in an amount greater than a preset threshold value as a change point and attaches a data label only to the change point. FIG. 6 shows an example in which a data label is attached with the threshold value set to 100.

As shown in FIG. 6, for the graph of the inspection item a, data labels are attached only to change points Pa1 and Pa2 where the inspection data are changed from 683 to 551 (−132), change points Pa3 and Pa4 where the inspection data have change from 502 to 811 (+309), and change points Pa5 and Pa6 where the inspection data are changed from 755 to 651 (−104). For the graphs of the inspection items b and c, no data label is attached as there is no change point where the amount of change exceeds 100.

As shown in FIG. 6, attaching a data label only to a change point of each graph makes the display very easy to observe and allows information required for diagnosis to be obtained, such as a timing where the inspection data are changed abruptly and the amount of change thereof.

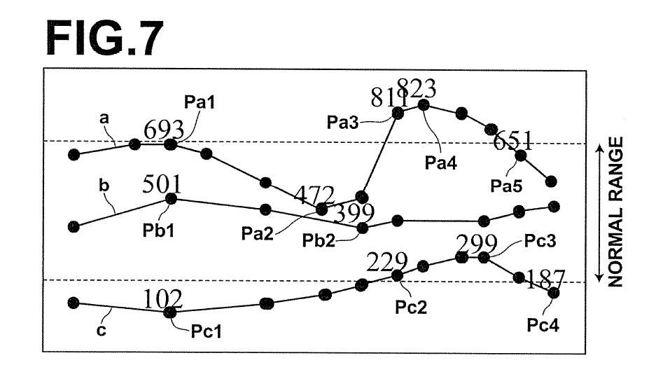

Although, the threshold value is 100 in the description of the third embodiment, the threshold value is not limited to this and may be set arbitrarily by the user. Further, the threshold value may be set separately for each inspection item. Further, change points of at least two of the first to third embodiments may be combined and data labels may be attached only to the combined change points. FIG. 7 shows an example in which data labels are attached only to the change points of the first and second embodiments. As shown in FIG. 7, for the graph of the inspection item a, data labels are attached to five change points, a change point Pal to a change point Pa5, for the graph of the inspection item b, data labels are attached to two change points, change points Pb1 and Pb2, and for the graph of the inspection item c, data labels are attached to four change points, a change point Pc1 to a change point Pc4.

Note that the first to third embodiments described above may be combined arbitrarily by the user. Further, any of the change points of the first to third embodiments may be selected by the user and data label may be attached only to the selected change point.

In a case where the change points in the first to third embodiments amount to a large number, data labels may be attached only to those of the change points where the inspection data have abnormal values.

Further, in a case where change points are set as in the first to third embodiments, there may be a case where the number of change points is zero and no data label is attached at all. In order to avoid such a case, the data label may be attached to at least one point of a maximum value, a minimum value, or an end point the graph of each inspection item, in addition to the change points in the first to third embodiments.

In the foregoing embodiments, a numerical value is attached as the data label, but the data label is not limited to this and, for example, with respect to a change point, a mark of a different color from those of change points other than the change point may be attached as the data label. In this case, a mark of a different color may be attached according to the amount of change at the change point. For example, a mark of a different color may be attached according to the amount of change in the slope in the first embodiment, a mark of a different color may be attached according to the difference between the upper or lower limit of normal values and inspection data of an abnormal value in the second embodiment. Further, a mark of a different color may be attached according to the amount of change in the inspection data in the third embodiment. Further, the data label is not limited to this and other symbols or keywords defined freely by the user may be attached as the data label.

What is claimed is:

1. An inspection data display control apparatus, comprising an inspection data obtaining unit that obtains inspection data of a plurality of inspection items obtained in time series and a display control unit that graph-displays inspection data of each inspection item obtained by the inspection data obtaining unit,
wherein the display control unit attaches a data label only to a change point in a graph of each inspection item and displays.

2. The inspection data display control apparatus of claim 1, wherein the change point is a point where the slope of the graph is changed from positive to negative or from negative to positive.

3. The inspection data display control apparatus of claim 1, wherein the change point is a point where the inspection data are changed from an abnormal value to a normal value or from a normal value to an abnormal value.

4. The inspection data display control apparatus of claim 1, wherein the change point is a point where the inspection data are changed in an amount greater than a preset threshold value.

5. The inspection data display control apparatus of claim 1, wherein the display control unit attaches the data label only to a point of the change points where the inspection data have an abnormal value.

6. The inspection data display control apparatus of claim 1, wherein the display control unit further attaches the data label to at least one point of a maximum value, a minimum value, and an end point of the graph of each inspection item, in addition to the change point.

7. The inspection data display control apparatus of claim 1, wherein the display control unit attaches a numerical value of the inspection data as the data label.

8. The inspection data display control apparatus of claim 1, wherein the display control unit attaches a colored mark as the data label.

9. The inspection data display control apparatus of claim 1, wherein the display control unit is capable of changing a display period of the inspection data.

10. An inspection data display control method, comprising the steps of
obtaining inspection data of a plurality of inspection items obtained in time series;
graph-displaying the obtained inspection data of each inspection item; and
attaching a data label only to a change point in a graph of each inspection item and displaying.

11. A non-transitory computer-readable recording medium containing an inspection data display control program for causing a computer to function as an inspection data obtaining unit that obtains inspection data of a plurality of inspection items obtained in time series and a display control unit that graph-displays inspection data of each inspection item obtained by the inspection data obtaining unit,
wherein the display control unit attaches a data label only to a change point in a graph of each inspection item and displays.
